(19) United States
(12) Patent Application Publication
(10) Pub. No.: US 2009/0181719 A1
(43) Pub. Date: Jul. 16, 2009

(54) MOBILE TELECOMMUNICATION TERMINAL HAVING CAMERA AND CONTROLLING METHOD FOR THE SAME

(76) Inventor: Sung Yeob Cho, Gwangmyeong-si (KR)

Correspondence Address: BIRCH STEWART KOLASCH & BIRCH, PO BOX 747, FALLS CHURCH, VA, 22040-0747, US

(21) Appl. No.: 12/352,751

(22) Filed: Jan. 13, 2009

(30) Foreign Application Priority Data
Jan. 14, 2008 (KR) 10-2008-0004148

(51) Int. Cl. H04M 1/00; H04N 9/68; G09G 3/36

(52) U.S. Cl. 455/556.1; 348/234; 345/102; 348/E09.053

(57) ABSTRACT

A mobile communication terminal having a camera and a controlling method thereof are provided. The controlling method may include: determining an operating state of the mobile communication terminal; converting a mode of the camera, installed in the mobile communication terminal, to a particular mode among at least one photographing mode according to the determined operating state of the mobile communication terminal; extracting a data value that is photographed in the converted particular mode; and adjusting a brightness of a display screen of the mobile communication terminal using the extracted data value.

### CROSS-REFERENCE TO RELATED APPLICATION

This application claims the benefit of Korean Patent Application No. 10-2008-0004148, filed on Jan. 14, 2008, in the Korean Intellectual Property Office, the disclosure of which is incorporated herein by reference.

### BACKGROUND

1. Field of the Invention

The present invention relates to a mobile communication terminal, and more particularly, to a mobile communication terminal having a camera and a controlling method thereof.

2. Description of the Related Art

Due to the rapid distribution of mobile communication terminals, many people currently carry them as daily necessity. The mobile communication terminal may be a wireless communication terminal that may perform a communication while a user is in motion. For example, the mobile communication terminal may be a cellular phone, a personal digital assistant (PDA), a portable multimedia player (PMP), an electronic dictionary, a notebook, and the like.

Particularly, the mobile communication terminal may provide various types of services such as a short messaging service, an Internet service, a schedule management service, and the like, in addition to a basic voice call service. The short messaging service may support various types of messaging services, for example, a general text message service, a photo-text messaging service including an image file, a motion picture mail service including motion picture information, and the like.

Also, according to diversified needs of users, a mobile communication terminal having a camera has been released in the market. A market portion of the mobile communication terminal having the camera is on the global increase.

However, the conventional mobile communication terminal having the camera may be limitedly used for a simple photographing operation, and the like.

Also, in the case of the conventional mobile communication terminal having the camera, only an ineffective scheme regarding a power consumption of a display screen is proposed. Accordingly, due to the unnecessary power consumption of the display screen, a running time of the mobile communication terminal may be significantly reduced. For example, when the mobile communication terminal uses a backlight, the above power consumption problem may be further deteriorated.

### SUMMARY

According to an aspect of the present invention, there is provided a method of controlling a mobile communication terminal having a camera, the method including: determining an operating state of the mobile communication terminal; converting a mode of the camera, installed in the mobile communication terminal, to a particular mode among at least one photographing mode according to the determined operating state of the mobile communication terminal; extracting a data value that is photographed in the converted particular mode; and adjusting a brightness of a display screen of the mobile communication terminal using the extracted data value.

According to another aspect of the present invention, there is provided a mobile communication terminal having a camera, including: a camera unit to photograph a still image or a motion picture; a decision unit to determine an operating state of the mobile communication terminal; a conversion unit to convert a mode of the camera, installed in the mobile communication terminal, to a particular mode among at least one photographing mode according to the determined operating state of the mobile communication terminal; a proximity decision unit to determine the proximity of a subject in the converted particular mode; and an adjustment unit to adjust a brightness of a display screen of the mobile communication terminal based on the decision result of the proximity decision unit.

Additional aspects, features, and/or advantages of the invention will be set forth in part in the description which follows and, in part, will be apparent from the description, or may be learned by practice of the invention.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a diagram illustrating an appearance of a mobile communication terminal having a camera according to an embodiment of the present invention;

FIG. 2 is a block diagram illustrating an internal configuration of a mobile communication terminal having a camera according to an embodiment of the present invention;

FIG. 3 is a diagram illustrating a database defining a mode for each operating state of a mobile communication terminal according to an embodiment of the present invention;

FIG. 4 is a diagram illustrating a database defining a brightness of a display screen for each luminance value of a mobile communication terminal according to an embodiment of the present invention;

FIG. 5 is a diagram illustrating a database defining a brightness of a display screen for each distance value of a mobile communication terminal according to an embodiment of the present invention;

FIG. 6 is a diagram illustrating a database defining a brightness of a display screen for each distance value of a mobile communication terminal according to another embodiment of the present invention;

FIG. 7 is a flowchart illustrating a method of controlling a mobile communication terminal having a camera according to an embodiment of the present invention; and

FIG. 8 is a flowchart illustrating a method of controlling a mobile communication terminal having a camera according to another embodiment of the present invention.

### DETAILED DESCRIPTION

Reference will now be made in detail to exemplary embodiments of the present invention, examples of which are illustrated in the accompanying drawings, wherein like reference numerals refer to the like elements throughout. Exemplary embodiments are described below to explain the present invention by referring to the figures.

Hereinafter, embodiments of the present invention will be described in detail with reference to the accompanying drawings, but they are not limited thereto or restricted thereby. When it is determined detailed description related to a related known function or configuration they make the purpose of the present invention unnecessarily ambiguous in describing the present invention, the detailed description will be omitted here. However, it will be readily understood by those skilled in the art from the following description.

Also, as far as terms used herein including a technical term or a scientific term are not particularly defined, they may have the same meaning as generally understood by those skilled in the art. Generally used terms that are defined in a dictionary may be interpreted to have the matching meaning to the lexical meaning of a related technology. Accordingly, if the terminals are not clearly defined herein, they may not be interpreted as an identical or excessively formal meaning.

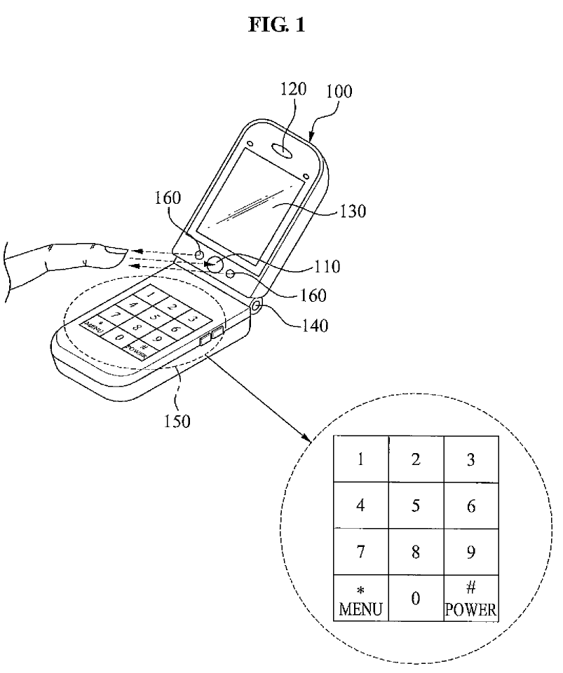

FIG. 1 illustrates an appearance of a mobile communication terminal 100 having a camera according to an embodiment of the present invention. Hereinafter, the mobile communication terminal 100 having the camera will be described with reference to FIG. 1.

The mobile communication terminal 100 includes a camera unit 110, a call receiver 120, a display screen 130, a hinge 140, a keypad 150, and light source units 160.

The camera unit 110 may be provided to be adjacent to the call receiver 120, or may be provided in various locations according to a user convenience. The camera unit 110 may photograph a still image or a motion picture. A mode of the camera unit 110 may be converted to a particular mode among a plurality of photographing modes according to an operating state of the mobile communication terminal 100.

The display screen 130 may use a backlight unit (BLU) to provide various types information for a user of the mobile communication terminal 100. In particular, when the mode of the camera unit 110 is converted to the particular mode among the plurality of photographing modes, the display screen 130 may adjust its brightness using a data value corresponding to the particular mode. Specifically, it is possible to reduce an unnecessary power consumption of the display screen 130 using the camera unit 110 installed in the mobile communication terminal 100.

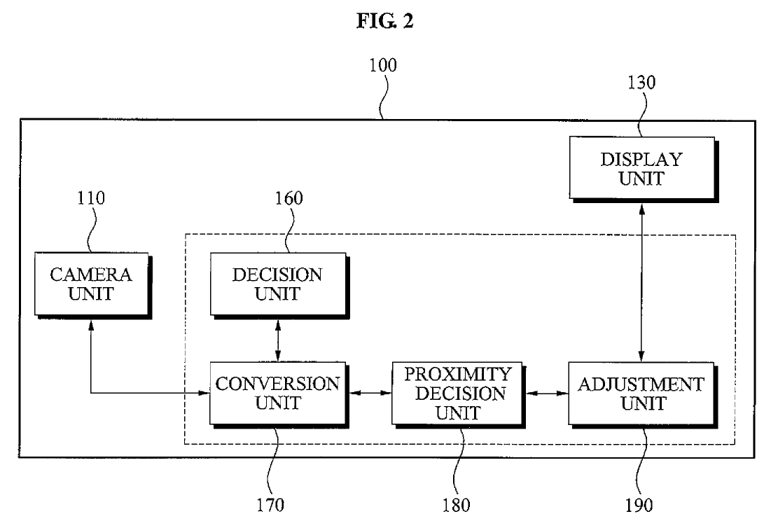

The light source unit 160 functions to emit a light to a subject. A number of light source units 160, a location thereof and the like may be determined so that the light emitted from the light source unit 160 may be reflected by the subject to thereby enter the camera unit 110. For example, a predetermined number of light source units 160 may be provided around the camera unit 110. As shown in FIG. 2, two light source units 160 may be provided, but the present invention is not limited thereto. A location of the subject may be a location of reflecting the light emitted from the light source unit 160. The subject may make a contact or no contact with the camera unit 110 or the mobile communication terminal 100. According to another embodiment of the present invention, the light source unit 160 may not be separately provided. The present invention may be performed using the light that is emitted from the display screen 130 of the mobile communication terminal 100 and is reflected by the subject to thereby enter the camera unit 110.

The light emitted from the light source unit 160 may be reflected by the subject and then continuously enter the camera unit 110. The camera unit 110 may create an image of the subject. The created image may be processed in a form of image data to extract motion of the subject. The camera unit 110 may perform a function of moving a pointer that is displayed on the display screen 130 in correspondence to the extracted motion of the subject, or may perform a control function in correspondence to the extracted motion of the subject.

FIG. 2 is a block diagram illustrating an internal configuration of a mobile communication terminal 100 having a camera according to an embodiment of the present invention. Hereinafter, the mobile communication terminal 100 having the camera will be described with reference to FIG. 2.

The mobile communication terminal 100 includes a camera unit 110, a decision unit 165, a conversion unit 170, a proximity decision unit 180, an adjustment unit 190, and a display screen 130.

Here, the mobile communication terminal 100 of FIG. 2 is based on a module that is directly or indirectly associated with the present invention, which may be applicable to other drawings as same. In this instance, blocks illustrated in this specification may be designed into a module. The module may denote a single unit that performs a particular function or operation. The module may be embodied into hardware or software, or may also be embodied by combination of hardware and software.

The camera unit 110 may photograph a still image or a motion picture. Also, a motion of the camera unit may be converted to at least one photographing mode.

The decision unit 165 may determine an operating state of the mobile communication terminal 100. The operating state may include various types of operating states, such as a standby state, a general call state, a video call state, and a key input ready state, and the like, which may be constructed into a database.

The conversion unit 170 may convert a mode of the camera unit 110 to a particular mode among at least one photographing mode according to the determined operating state of the mobile communication terminal 100. The mode of the camera mode 110 may be converted to various types of photographing modes, for example, a luminance measurement mode, a proximity detection mode, an image sensor mode, and a motion recognition mode, and the like. Each mode may be designed to be automatically converted according to each corresponding operating state of the mobile communication terminal 100.

The proximity decision unit 180 may determine the proximity of the subject that is photographed in the converted particular mode. The proximity decision unit 180 may determine the proximity of the subject based on processing of the image photographed by the camera.

When the current operating state of the mobile communication terminal 100 is in the standby state as a result of the decision of the decision unit 165, the conversion unit 170 may convert the current mode of the camera unit 110 to the luminance measurement mode, and the proximity decision unit 180 may extract a measured luminance value according to the luminance measurement mode.

Also, for example, when the current operating state of the mobile communication terminal 100 is in the general operating state as a result of the decision of the decision unit 165, the conversion unit 170 may convert the current mode of the camera unit 110 to the proximity detection mode, and the proximity decision unit 180 may extract a distance value between the subject, photographed in the proximity detection mode, and the mobile communication terminal 100.

The adjustment unit 190 may adjust a brightness of the display screen 130 using the above data value that is extracted by the proximity decision unit 180.

The camera unit 110, the decision unit 165, the conversion unit 170, the proximity decision unit 180, and the adjustment unit 190 constituting the mobile communication terminal 100 may be connected to a system controller (not shown) of the mobile communication terminal 100 and a single communication line, or may be constructed into a single chip module.

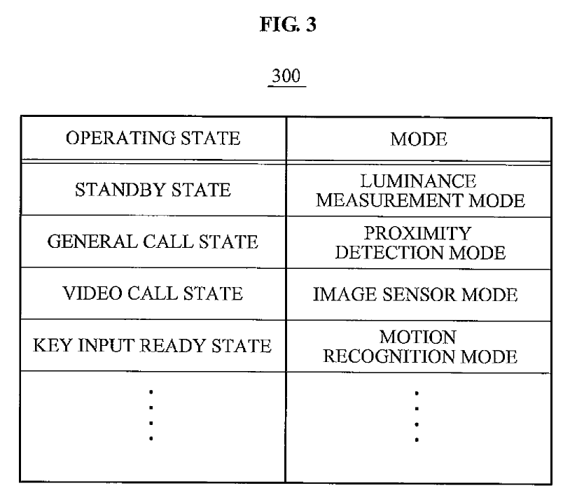

FIG. 3 is a diagram illustrating a database 300 defining a mode for each operating state of a mobile communication terminal according to an embodiment of the present invention. Hereinafter, the mode for each operating state of the mobile communication terminal will be described with reference to FIG. 3.

As shown in FIG. 3, the database 300 may include modes respectively corresponding to operating states of the mobile communication terminal. Accordingly, it is possible to convert a mode of a camera, installed in the mobile communication terminal, to various types of modes according to each corresponding operating state of the mobile communication terminal.

For example, when the mobile communication terminal is in a standby state, the mode of the camera may be converted to a luminance measurement mode. When the mobile communication terminal is in a general call state, the mode of the camera may be converted to a proximity detection mode. When the mobile communication terminal is in a video call state, the mode of the camera may be converted to an image sensor mode. When the mobile communication terminal is in a key input ready state, the mode of the camera may be converted to a motion recognition mode.

More specifically, when the mobile communication terminal is in the standby state, the mode of the camera may be converted to the luminance measurement mode to extract a measured luminance value and adjust a brightness of a display screen to be in inverse proportion to the extracted luminance value.

Also, when the mobile communication terminal is in the general call state, the mode of the camera may be converted to the proximity detection mode to extract a distance value between the subject, photographed in the proximity detection mode, and the mobile communication terminal and control the display screen to maintain an on-state or an off-state depending on whether the extracted distance value is less than or equal to a predetermined threshold.

Also, when the mobile communication terminal is in the video call state, the mode of the camera may be converted to the image sensor mode to transmit image data, photographed in the image sensor mode, to a correspondent mobile communication terminal.

Also, when the mobile communication terminal is in the key input ready state, the mode of the camera may be converted to the motion recognition mode to detect the image data, photographed in the motion recognition mode, and generate a particular command signal corresponding to the detected image data and thereby control the mobile communication terminal to operate according to the particular command signal.

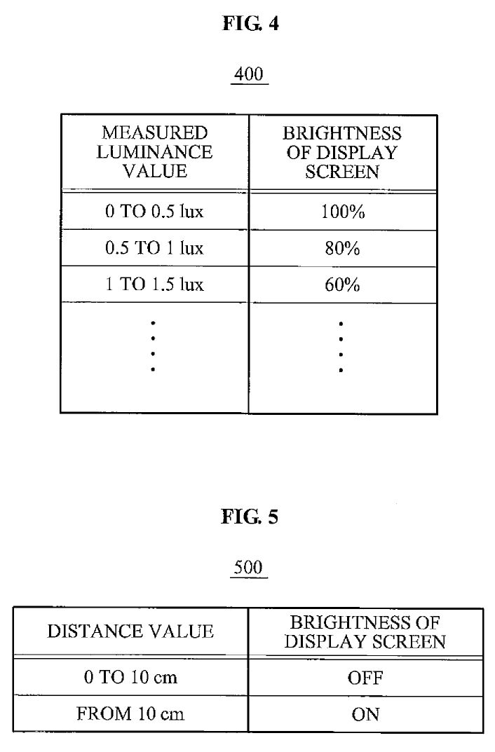

FIG. 4 is a diagram illustrating a database 400 defining a brightness of a display screen for each luminance value of a mobile communication terminal according to an embodiment of the present invention. Hereinafter, the brightness of the display screen for each luminance value of the mobile communication terminal will be described with reference to FIG. 4.

The database 400 shown in FIG. 4 defines the brightness of the display screen, The database 400 shows an example of the brightness of the display screen according to the luminance value that is measured when the mobile communication terminal is in a standby state and in this instance, a mode of a camera installed in the mobile communication terminal is converted to a luminance measurement mode.

For example, when the mobile communication terminal is in the standby state, the mode of the camera may be converted to the luminance measurement mode to thereby measure a luminance value and extract the measured luminance value. When the extracted luminance value is between zero and 0.5 lux, it may be determined a surrounding environment of the mobile communication terminal is relatively dark whereby the display screen may provide 100% of brightness corresponding to its maximum brightness.

Also, when the measured luminance value is greater than the above range, for example, between 1.5 and 1 lux or between 1 and 1.5 lux, the display screen may provide a brightness corresponding thereto, for example, 80% to 60% brightness of the maximum brightness. The above numerical values are only an example, and thus it may be possible to design the brightness of the display screen into other numerical values according to a user environment, a mobile communication terminal characteristic, and the like.

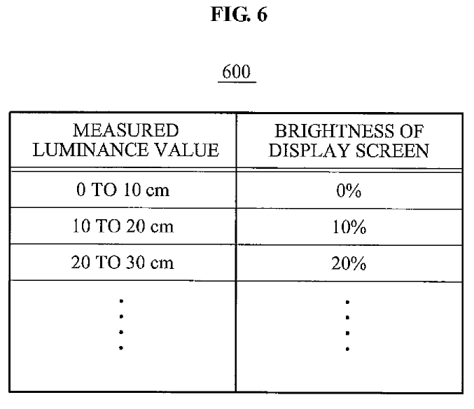

FIG. 5 is a diagram illustrating a database 500 defining a brightness of a display screen for each distance value of a mobile communication terminal according to an embodiment of the present invention. FIG. 6 is a diagram illustrating a database 600 defining a brightness of a display screen for each distance value of a mobile communication terminal according to another embodiment of the present invention. Hereinafter, the brightness of the display screen for each distance value of the mobile communication terminal will be described with reference to FIGS. 5 and 6.

The databases 500 and 600 define the brightness of the display screen according to each corresponding distance value when the mobile communication terminal is in a general call state. When the mobile communication terminal is in the general call state, a mode of a camera installed in the mobile communication terminal may be converted to a proximity detection mode to thereby extract a distance value between a subject, photographed in the proximity detection mode, and the mobile communication terminal. The extracted distance value may be used as a reference to control the display screen.

For example, as shown in the database 500 of FIG. 5, when it is determined the mobile communication terminal is very close to the photographed subject, it may be determined the probability of using the display screen is very low and thereby turn off the display screen. Conversely, when it is determined the mobile communication terminal is separated away from the photographed subject, it may be determined the probability of using the display screen is high and thereby turn on the display screen.

Specifically, when the mobile communication terminal is in the general call state, the display screen may be controlled to be turned on or off based on the distance value with the photographed subject. In this instance, in order to turn on or off the display screen, the distance value with the photographed subject may be determined to be between zero cm and 10 cm, or to be greater than 10 cm. The distance value may be adjusted to more appropriately adjust the brightness of the display screen.

As shown in the database 600 of FIG. 6, when the distance with the photographed subject is between zero cm and 10 cm, the brightness of the display screen may be adjusted to zero % of the maximum brightness. When the distance value is between 10 cm and 20 cm, the brightness of the display screen may be adjusted to 10% of the maximum brightness. When the distance value is between 20 cm to 30 cm, the brightness of the display screen may be adjusted to 20% of the maximum brightness. As the distance value with the photographed subject is separated away, it may be considered that the probability of using the display screen increases whereby it is possible to control the brightness of the display screen to be brighter the above numerical values are only an example and thus it may be possible to design the distance value to various numerical values according to a user environment, a mobile communication terminal characteristic, and the like.

Accordingly, the brightness of the display screen may be more appropriately controlled according to various distance values with the subject.

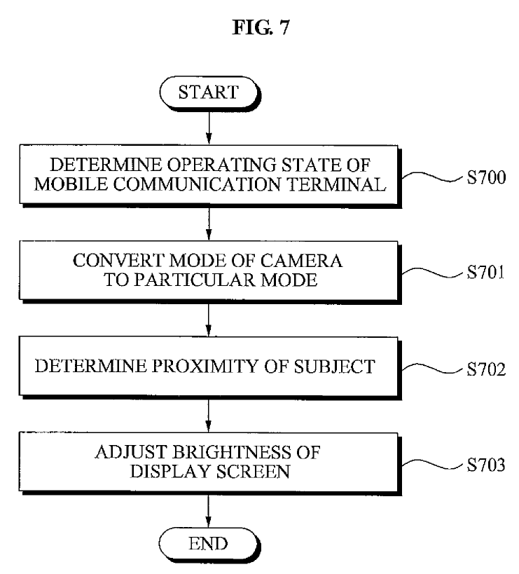

FIG. 7 is a flowchart illustrating a method of controlling a mobile communication terminal having a camera according to an embodiment of the present invention. Hereinafter, the controlling method of the mobile comnmunication terminal having the camera will be described with reference to FIG. 7.

In operation S700, the controlling method of the mobile communication terminal may determine an operating state of the mobile communication terminal. In operation S701, the controlling method may convert a mode of the camera, installed in the mobile communication terminal, to a particular mode among at least one photographing mode. Specifically, the controlling method may determine whether the mobile communication terminal is in a standby state, a general call state, a video call state, or a key input ready state to thereby convert the mode of the camera to the particular mode according to each corresponding operating state of the mobile communication terminal.

In operation S702, the controlling method may determine the proximity of a subject in the converted particular mode. In operation S703, the controlling method may adjust a brightness of a display screen of the mobile communication terminal based on the decision result.

In this instance, the controlling method may determine the proximity of the subject based on processing of an image photographed by the camera.

Also, when the determined operating state of the mobile communication terminal is in the standby state, the mode of the camera may be converted to a luminance measurement mode to measure a luminance value and extract the measured luminance value and thereby adjust the brightness of the display screen to be in inverse proportion to the extracted luminance value.

Also, when the determined operating state of the mobile communication terminal is in the general call state, the mode of the camera may be converted to a proximity detection mode to extract a distance value between the subject, photographed in the proximity detection mode, and the mobile communication terminal, and control the display screen to be turned on or off based on the extracted distance value.

Also, when the determined operating state of the mobile communication terminal is in the video call state, the mode of the camera may be converted to an image sensor mode to control image data, photographed in the image sensor mode, to a correspondent mobile communication terminal. Also, when the determined operating state of the mobile communication is in the key input ready state, the mode of the camera may be converted to a motion recognition mode to generate a command signal corresponding to the image data photographed in the motion recognition mode, and thereby control the mobile communication terminal to operate according to the command signal.

The brightness of the display screen may be classified into at least one step corresponding to each data value. The brightness of the display screen may be adjusted to the at least one step.

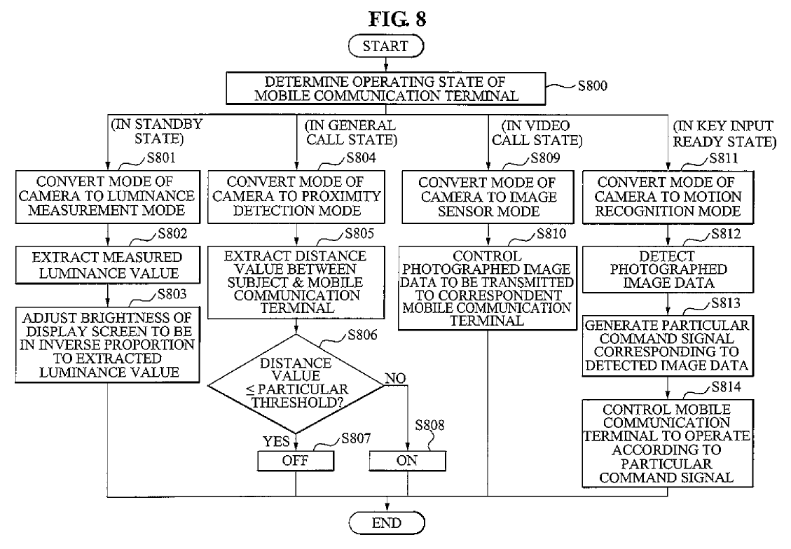

FIG. 8 is a flowchart illustrating a method of controlling a mobile communication terminal having a camera according to another embodiment of the present invention. Hereinafter, the controlling method of the mobile communication terminal having the camera will be described in detail with reference to FIG. 8. In comparison to the flowchart of FIG. 7, the flowchart of FIG. 8 shows the controlling method further in detail. Accordingly, those skilled in the art may more readily comprehend and perform the invention with reference to FIGS. 7 and 8.

In operation S800, the controlling method may periodically determine an operating state of the mobile communication state.

When the determined operating state of the mobile communication state is in a standby state, the controlling method may convert a mode of the camera to a luminance measurement mode among at least one photographing mode in operation S801.

In operation S802, the controlling method may extract a luminance value in the converted luminance measurement mode. According to an embodiment of the present invention, the luminance value may be extracted through a configuration including a luminance operating unit (not shown) to operate a luminance sensor for sensing a luminance, a luminance measurement unit (not shown) to measure a luminance value of the luminance sensed by the luminance sensor, and a luminance inform unit (not shown) to inform a user of the luminance value measured by the luminance measurement unit.

In operation S803, the controlling method may adjust a brightness of a display screen of the mobile communication terminal to be in inverse proportion to the extracted luminance value.

When the determined operating state of the mobile communication terminal is in a general call state, the controlling method may convert the mode of the camera to a proximity detection mode among the at least one photographing mode in operation S804.

In operation S805, the controlling method may extract a distance value between a subject, photographed in the converted proximity detection mode, and the mobile communication terminal. Hereinafter, an example of extracting the distance value between the photographed subject and the mobile communication terminal will be described in detail.

In a state where a light source unit is activated, light image data may be generated by photographing a subject. In a state where the light source unit is inactivated, no-light image data may be generated by photographing the subject. Third image data may be generated by comparing the light image data and the no-light image data. m^{th} subject size information may be generated by analyzing the generated third image data. The generated m^{th} subject size information may be compared with a first boundary value. Next, k^{th} subject size information may be generated and the generated m^{th} subject size information may be compared with the first boundary value. In correspondence to a comparison result between the m^{th} subject size information and the first boundary value, and a comparison result between the k^{th} subject size information and the first boundary value, a function execution command may be generated and be output in a particular location of a predetermined outline.

Here, m is a natural number and k may be designed to be a natural number greater than m.

In operation S806, the controlling method may determine whether the extracted distance value is less than or equal to a particular threshold. When the extracted distance value is less than or equal to the particular threshold, the controlling method may convert the brightness of the display screen to an off-state in operation S807. Conversely, when the extracted distance value is greater than the particular threshold, the controlling method may convert the brightness of the display screen to an on-state in operation S808.

In operation S809, when the determined operating state of the mobile communication terminal is in a video call state, the controlling method may convert the mode of the camera to an image sensor mode among the at least one photographing mode.

In operation S810, the controlling method may control image data, photographed in the image sensor mode, to be transmitted to a correspondent mobile communication terminal.

In operation S811, when the determined operating state of the mobile communication terminal is in a key input ready state, the controlling method may convert the mode of the camera to a motion recognition mode among the at least one photographing mode.

In operation S812, the controlling method may detect the image data photographed in the converted motion recognition mode. In operation S813, the controlling method may generate a particular command signal corresponding to the detected image data. In operation S814, the controlling method may control the mobile communication terminal to operate according to the particular command signal.

Specifically, for example, when detecting the photographed image data, it is possible to photograph an image associated with a hand gesture of a user, generate mouse coordinate information and direction information based on information associated with the hand gesture, and to control the mobile communication terminal to operate based on the generated mouse coordinate information and direction information.

According to embodiments of the present invention, it is possible to reduce an unnecessary power consumption of a display screen of a mobile communication terminal using a camera installed in the mobile communication terminal.

Also, according to embodiments of the present invention, it is possible to automatically determine a particular state of a mobile communication terminal and control a power consumption of a display screen for each step according to a corresponding mode and thereby more effectively consume the power.

Also, according to embodiments of the present invention, it is possible to embody various types of functions in a single chip using a camera and thereby significantly reduce an installation space of parts and costs. More specifically, for example, when embodying a motion recognition function, a luminance measurement function, a proximity detection function, and the like using the camera, only the result may be output through image processing in the single chip. Accordingly, it is possible to reduce loads in a system controller, for example, a baseband of a mobile communication terminal and to quickly process data and thereby improve a user convenience. Also, since all the functions associated with the camera may be controlled using a single control scheme and a signal line, a product design and a control may be further simplified.

As described above, according to example embodiments of the present invention, there may be provided a mobile communication terminal that may control a power consumption of a display screen for each step according to a corresponding mode and thereby enable a more effective power consumption, and a controlling method thereof.

The term “mobile communication terminal” used in the present specification includes portable devices, such as a Personal Digital Cellular (PDC) phone, a personal communication service (PCS) phone, a personal handyphone system (PHS) phone, a Code Division Multiple Access (CDMA)-2000 (1×, 3×) phone, a Wideband CDMA phone, a dual band/dual mode phone, a Global Standard for Mobile Communications (GSM) phone, a mobile broadband system MBS) phone, a Digital Multimedia Broadcasting (DMB) phone, a smart phone, and a cellular phone; portable terminals such as a personal digital assistant (PDA), a hand-held PC, a notebook computer, a laptop computer, a wireless broadband Internet (WiBro) terminal, an MP3 player, and an MD player; and all types of hand-held based wireless communication devices including an International Mobile Telecommunication (IMT)-2000 providing international roaming service and extended mobile communication service. Also, the mobile communication terminal may include a predetermined communication module such as a CDMA module, a Bluetooth module, an Infrared Data Association (IrDA) module, a wired/wireless LAN card, and a wireless communication device which is provided with a global positioning system (GPS) chip enabling tracking of a position via a GPS. Also, the mobile communication terminal may include a microprocessor that may play multimedia and perform a certain calculation operation.

The controlling method of the mobile communication terminal according to the above-described exemplary embodiments of the present invention may be recorded in computer-readable media including program instructions to implement various operations embodied by a computer. The media may also include, alone or in combination with the program instructions, data files, data structures, and the like. Examples of computer-readable media include magnetic media such as hard disks, floppy disks, and magnetic tape; optical media such as CD ROM disks and DVDs; magneto-optical media such as floptical disks; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described exemplary embodiments of the present invention, or vice versa.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. A method of controlling a mobile communication terminal having a camera, the method comprising:
determining an operating state of the mobile communication terminal;
converting a mode of the camera, installed in the mobile communication terminal, to a particular mode among at least one photographing mode according to the determined operating state of the mobile communication terminal;
extracting a data value that is photographed in the converted particular mode; and
adjusting a brightness of a display screen of the mobile communication terminal using the extracted data value.

2. The method of claim 1, wherein, when the determined operating state of the mobile communication terminal is in a standby state, the converting comprises converting the mode of the camera to a luminance measurement mode, and the extracting comprises extracting a measured luminance value.

3. The method of claim 1, wherein, when the determined operating state of the mobile communication terminal is in a general call state, the converting comprises converting the mode of the camera to a proximity detection mode, and the extracting comprises determining the proximity of a subject in the proximity detection mode.

4. The method of claim 3, wherein the determining the proximity of the subject in the proximity detection mode comprises determining the proximity of the subject based on an image photographed by the camera.

5. The method of claim 1, wherein the adjusting comprises adjusting a liquid crystal display (LCD) backlight of the mobile communication terminal to a particular step among at least one step.

6. The method of claim 1, further comprising:
converting the mode of the camera of the mobile communication terminal to an image sensor mode among the at least one photographing mode, when the determined operating state of the mobile communication terminal is in a video call state; and
controlling image data, photographed in the converted image sensor mode, to be transmitted to a correspondent mobile communication terminal.

7. The method of claim 1, further comprising:
converting the mode of the camera of the mobile communication terminal to a motion recognition mode among the at least one photographing mode, when the determined operating state of the mobile communication terminal is in a key input ready state;
detecting image data that is photographed in the converted motion recognition mode;
generating a particular camera signal corresponding to the detected image data; and
controlling the mobile communication terminal to operate according to the generated particular command signal.

8. A computer-readable recording medium storing a program for implementing the method of claim 1.

9. A mobile communication terminal having a camera, comprising.
a camera unit to photograph a still image or a motion picture;
a decision unit to determine an operating state of the mobile communication terminal;
a conversion unit to convert a mode of the camera, installed in the mobile communication terminal, to a particular mode among at least one photographing mode according to the determined operating state of the mobile communication terminal;
a proximity decision unit to determine the proximity of a subject in the converted particular mode; and
an adjustment unit to adjust a brightness of a display screen of the mobile communication terminal based on the decision result of the proximity decision unit.

10. The mobile communication terminal of claim 9, wherein, when the determined operating state of the mobile communication terminal is in a standby state, the conversion unit converts the mode of the camera to a luminance measurement mode, and the decision unit extracts a measured luminance value.

11. The mobile communication terminal of claim 9, wherein, when the determined operating state of the mobile communication terminal is in a general call state, the conversion unit converts the mode of the camera to a proximity detection mode, and the proximity decision unit determines the proximity of the subject based on processing of an image that is photographed by the camera in the proximity detection mode.

12. The mobile communication terminal of claim 9, wherein the camera unit, the decision unit, the conversion unit, the proximity decision unit, and the adjustment unit are connected to a system controller of the mobile communication terminal and a single communication line, and are constructed as a single chip module.
